(19) United States
(12) Patent Application Publication
(10) Pub. No.: US 2006/0238153 A1
(43) Pub. Date: Oct. 26, 2006

(54) Handwheel-operated device

(76) Inventors: Craig Duncan Webster, Cambridge (GB); Simon James Naylor, Cambridge (GB)

Correspondence Address: BARNES & THORNBURG LLP, P.O. BOX 2786, CHICAGO, IL, 60690-2786, US

(21) Appl. No.: 10/560,196

(22) PCT Filed: Jun. 11, 2004
(86) PCT No.: PCT/GB04/02528

§ 371 Date: May 9, 2006

(30) Foreign Application Priority Data
Jun. 11, 2003 (GB) 03134707
Sep. 12, 2003 (GB) 03213618
Oct. 8, 2003 (GB) 03234770

(51) Int. Cl. H02P 1/00

(52) U.S. Cl. 318/280

(57) ABSTRACT

A handwheel-operated device comprising a fixed body, a handwheel and a moveable body, the handwheel being rotatable relative to the fixed body and the moveable body moveable relative to the fixed body, and the device further comprising a first motor operable to actuate the moveable body, first sensor means responsive to the rotation of the handwheel and first control means operable in conjunction with the first sensor means to cause the first motor to rotate upon an angular displacement and/or angular velocity of the handwheel.

### FIELD OF THE INVENTION

This invention relates to a handwheel-operated device and to a method of controlling a motor of a handwheel-operated device by sensing rotation of the handwheel and causing the motor to move a moveable body such as a window, seat or sunroof in dependence upon the rotation of the handwheel.

### BACKGROUND TO THE INVENTION

Mechanical devices of the kind having a handwheel that causes the actuation of a body through a gear train are well known. Hand operated windows, sunroofs and seats in automotive vehicles are examples of such devices. These handwheel-operated devices are popular because a handwheel affords a high degree of control over the movement of the body. However, the level of force/torque that can be generated to move the body is limited by the user and the losses in the system such that considerable movement is required of the user. This is not popular with the users and impossible for those who lack the physical strength.

### SUMMARY OF THE INVENTION

According to a first aspect of the invention there is provided a handwheel-operated device comprising a fixed body, a handwheel and a moveable body, the handwheel being rotatable relative to the fixed body and the moveable body moveable relative to the fixed body, and the device further comprising a first motor operable to actuate the moveable body, first sensor means responsive to the rotation of the handwheel and first control means operable in conjunction with the first sensor means to cause the first motor to rotate upon an angular displacement and/or angular velocity of the handwheel.

The invention therefore provides a handwheel-operated device that is operable in the same manner as a conventional handwheel-operated device, such as a hand operated window, sunroof or seat, but which, for a particular speed and torque applied to the handwheel, is capable of developing considerably more speed and force on the moveable body than would a conventional handwheel-operated device.

The first control means may advantageously be operable to modulate a voltage applied to the first motor.

The first control means may advantageously be operable to modulate the voltage applied to the first motor such that the magnitude of the voltage is substantially proportional to the angular velocity of the handwheel.

This type of first control means is relatively straightforward to implement.

The first control means is preferably operable to modulate the voltage applied to the first motor such that an angular displacement and/or angular velocity of the handwheel results in a corresponding displacement and/or velocity of the moveable body.

With this type of first control means, the response of the moveable body to rotation of the handwheel is much closer to that of a conventional handwheel-operated device, where the handwheel and moveable body are mechanically coupled to one another, for example by a gear train, since changes in the loading on (i.e. resistance to movement of) the moveable body will not alter the relationship between handwheel and the moveable body's position and/or speed.

The first control means is more preferably operable to modulate the voltage applied to the first motor in dependence on the angular velocity of the handwheel such that the velocity of the moveable body is non-linearly related to the angular velocity of the handwheel, the ratio of handwheel speed to moveable body speed decreasing with increasing handwheel speed. An increase in handwheel speed causes a greater than proportionate increase in moveable body speed, and this type of first control means therefore enables a user to obtain very precise control of the displacement of the moveable body at low speeds of rotation of the handwheel, yet also to obtain high velocities of the moveable body that would otherwise require speeds of rotation of the handwheel that would be difficult or impossible for the user to achieve or sustain.

Precise control of the movement of the moveable body is useful where the device is used, for example, to control the horizontal position of a seat in a car where the user wishes to fine-tune the seat to their preferences.

Preferably the first control means is operable to cause the polarity of the voltage applied to the first motor to be dependent on the sense of rotation of the handwheel so that changing the direction of rotation of the handwheel reverses the polarity of the voltage applied to the first motor, and hence reverses the direction of movement of the moveable body.

The first control means may advantageously include a proportional-plus-integral (PI) controller. In that case, the first control means may advantageously be operable to turn off the PI controller if the speeds of movement of the handwheel and moveable body fall below respective first threshold speeds.

Preferably the first control means is operable to turn on the PI controller if the speed of rotation of the handwheel rises above a second threshold speed. Preferably the second threshold speed is greater than the first threshold speed.

Turning off the PI controller at low speeds of rotation of the handwheel has been found to be necessary to prevent “creep” of the moveable body, that is slow movement of the moveable body when the handwheel is stationary, due to steady-state errors in the PI controller.

The device may advantageously further comprise a variable low-pass signal filter operable to receive signals representative of the angular displacement and/or angular velocity of the handwheel from the first sensor means and to transmit signals below a cut-off frequency to the first control means and to attenuate signals above the cut-off frequency so as to prevent them from reaching the first control means, the cut-off frequency being determined by the angular velocity of the handwheel.

Preferably the variable low-pass signal filter is operable to decrease the cut-off frequency with increases of angular velocity of the handwheel up to a threshold angular velocity, above which increases of angular velocity of the handwheel do riot affect the cut-off frequency.

The effect of the variable low-pass signal filter is to cause the first control means to react relatively quickly to changes of angular displacement and/or angular velocity of the handwheel at low speeds of rotation of the handwheel, and relatively slowly to changes of angular displacement and/or angular velocity at higher speeds of rotation of the handwheel. This has been found to be necessary to give an accurate response of the speed of movement of the moveable body to changes of the speed of rotation of the handwheel at low speeds of rotation of the handwheel, which gives a user of the device the same impression of control of the speed of movement of the moveable body as is obtained with a conventional mechanical device, but avoids an overly abrupt response of the speed of movement of the moveable body to changes of the speed of rotation of the handwheel at high speeds of rotation of the handwheel. Such an abrupt response of the speed of movement of the. moveable body to changes of the speed of rotation of the handwheel is generally prevented in a conventional mechanical device as a result of the inertia of the handwheel, gear train and moveable body of the mechanical device.

The first sensor means may advantageously comprise an angular displacement sensor. Suitable angular displacement sensors include a claw pole motor, an arrangement of a slotted disc rotatable relative to one or more optical sensors, or an arrangement of a multipole magnet rotatable relative to one or more Hall effect sensors and/or coils, which may be one or more printed coils on a printed circuit board. Where the arrangement of the multipole magnet and one or more coils is used, the first control means may be operable either to count pulses generated by the one or more coils, or to sample analogue voltage signals generated by the one or more coils. Typically the slotted disc or multipole magnet is mounted on a shaft of the angular displacement sensor. In that case, the handwheel may advantageously be attached to the shaft of the angular displacement sensor.

Preferably, however, a first gear wheel is attached to the shaft of the angular displacement sensor, a second gear wheel is attached to the handwheel, and the first and second gear wheels are engageable with one another either directly or via one or more intermediate gears, so that each revolution of the second gear wheel causes the first gear wheel to rotate through more than 360°, preferably a plurality of revolutions.

In this way, an inexpensive low-resolution angular displacement sensor, which produces, say, eight pulses during one revolution, of its shaft, can be used, because each revolution of the handwheel will cause several revolutions of the shaft of the angular displacement sensor, and therefore a multiple of eight pulses during a revolution of the handwheel. Thus, provided that the ratio of the diameters of the first and second gear wheels is sufficiently large, the performance of an expensive high-resolution angular displacement sensor can be obtained using an inexpensive low-resolution angular displacement sensor.

Alternatively or additionally, the first sensor means may advantageously comprise a second motor, a shaft of which is coupled for rotation to the handwheel, and measurement means for measuring one or more parameters related to a speed and direction of rotation of the shaft of the second motor, and computation means operable to derive a speed and direction of rotation of the shaft of the second motor, and hence a speed and direction of rotation of the handwheel, from the one or more measured parameters.

Preferably the measurement means is operable to measure a back electromotive force (emf) generated by the second motor.

Where the first sensor means includes both a second motor and an angular displacement sensor, the shaft of the angular displacement sensor may advantageously be coupled for rotation to the rotor of the second motor, and the first gear wheel be attached to the shaft of the second motor.

The device may advantageously further comprise second sensor means operable to determine a torque developed by the first motor, torque feedback means coupled to the handwheel and second control means operable in conjunction with the second sensor means to cause the torque feedback means to oppose the rotation of the handwheel.

In this way a user of the device may be provided with an indication of the torque developed by the first motor, which adds to the user's impression of a mechanical coupling between the handwheel and the moveable body.

The second sensor means may advantageously comprise a force sensor and the first motor and/or gearing be mounted in the body of the device such that, in use, a torque developed by the first motor causes a torsional reaction force to be exerted on the force sensor.

Alternatively the second sensor means may advantageously comprise a force sensor mounted between the fixed body and the moveable body of the device such that, in use, the force applied to the moveable body causes a reaction force to be exerted on the force sensor.

The force sensor may advantageously be a piezoelectric crystal.

Alternatively, the second sensor means may advantageously comprise measurement means for measuring one or more parameters related to the torque of the first motor, and computation means operable to derive a torque of the first motor from the one or more measured parameters.

Preferably the measurement means is operable to measure a current supplied to the first motor.

The torque feedback means may advantageously comprise a variable brake engageable with the handwheel under the control of the second control means.

Where the first sensor means includes a second motor, the torque feedback means may more advantageously still comprise a second control means that is operable to supply current to the second motor so as to oppose the rotation of the handwheel.

The device preferably further comprises third sensor means operable to determine an electromotive force (emf) developed by the supply voltage, and the first control means is preferably operable in conjunction with the third sensor means to modulate the voltage applied to the first motor so that decreases in the emf do not cause decreases of the speed of the moveable body.

The device may advantageously further comprise fourth sensor means operable to determine a magnitude of a current supplied to the first motor, and the first control means may advantageously be operable in conjunction with the fourth sensor means to limit the magnitude of the current supplied to the first motor if the magnitude of the current exceeds a threshold level.

The device may advantageously further comprise biasing means and mechanical braking means, the biasing means being operable to urge the mechanical braking means into engagement with the handwheel so as to oppose the rotation of the handwheel.

The mechanical braking means has been found to smooth the response of the moveable body to rotation of the handwheel, and to prevent unintended rotation of the handwheel, for example rotation of the handwheel due to the weight of a handle attached to the handwheel, which would otherwise cause unintended movement of the moveable body.

Preferably the mechanical friction means is a felt-covered pad.

The handwheel may advantageously be provided with a handle movable between a folded position and an extended position.

The handwheel may advantageously further comprise latch means operable releasably to retain the handle in the extended position.

The body of the device and the handle of the handwheel may advantageously be formed such that in the folded position the handle engages with the body so as to prevent rotation of the handle relative to the body.

Preferably the device further comprises first switch means engageable with the handle, such that the first control means is operable to cause the first motor to move the moveable body only when the handle is in the extended position.

Alternatively or additionally, the device may advantageously further comprise a first further manual control (for example a rocker switch), movable between a “direction 1” position, at “off” position and a “direction 2” position, wherein movement of the first further manual control to the “direction 1” position causes the first motor to move the moveable body in one direction and the “direction 2” position causes movement in the opposite direction.

Preferably the device is a hand controlled actuator.

In one embodiment of the invention the device is to control the level to which a window is open.

In another embodiment of the invention the device controls control the level to which a sunroof is open.

In another embodiment of the invention the device controls this position of the occupant's seat.

According to a second aspect of the invention there is provided a method of controlling a motor of a handwheel-operated device, the device having a fixed body, a handwheel, a moveable body, gearing and a motor, the handwheel being rotatable relative to the fixed body and the motor being operable to move the moveable body relative to the fixed body, the method comprising sensing rotation of the handwheel and causing the motor to move the moveable body in dependence upon the angular displacement or angular velocity of the handwheel.

### BRIEF DESCRIPTION OF DRAWING FIGURES

The invention will now be described by way of illustrative example and with reference to the accompanying drawings, in which:

FIG. 1 is a schematic sectional view of a window opener in accordance with the first aspect of the invention;

FIG. 2 is a partial schematic sectional view of the force sensor of FIG. 1;

FIG. 3 is a block diagram of a first control scheme for the window opener of FIG. 1;

FIG. 4 is a block diagram of a second control scheme;

FIG. 5 is a block diagram of a third control scheme;

FIG. 6 is a block diagram of a fourth control scheme;

FIG. 7 is a graph of amplifier gain and hence velocity of the moveable body against angular velocity of the handwheel;

FIG. 8 is a block diagram of a, detail of the fourth control scheme;

FIG. 9 is a block diagram of a fifth control scheme;

FIG. 10 is a side view of seat position control in accordance with the first aspect of the invention;

FIG. 11 is a block diagram of a motor model used in the fifth control scheme;

FIG. 12 is a graph of the cut-off frequency of a variable filter against the angular velocity of the handwheel;

FIG. 13 is a sectional view of a handwheel and a mechanical brake assembly; and

FIG. 14 is a sectional view of a handwheel and flier manual control.

### DETAILED DESCRIPTION OF EMBODIMENTS

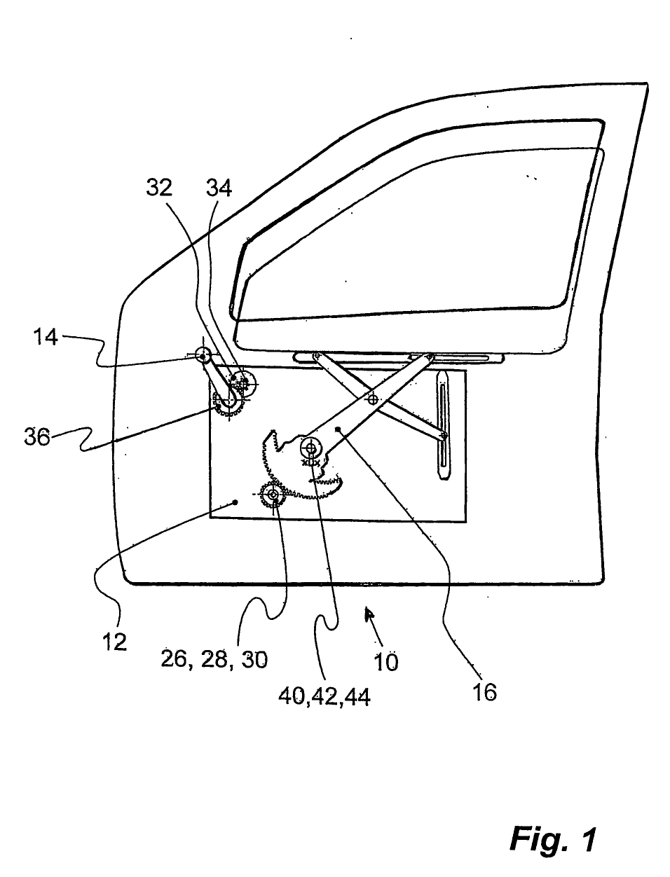

The automotive door 10 of FIG. 1 comprises a fixed body 12, a handwheel 14 and a window mechanism 16. The door 10 superficially resembles a conventional door with hand operated window. The body 12 contains a first motor 26, a first rotary encoder 28, a gearbox 30, a second motor 32, a second rotary encoder (not shown), and first and second gear wheels 34 and 36, respectively. The first rotary encoder 28 is made up of a multipole magnet and three Hall effect detectors and is attached to a first end of the spindle of the first motor 26. The gearbox 30 is coupled to a second end of the spindle of the first motor 26 and to the window mechanism 16.

It will be appreciated by those skilled in the art that it may not be necessary to have a separate rotary encoder to implement the first rotary encoder 28, and that an arrangement, for example, of a magnetised gear wheel forming part of the gearbox 30 and three Hall effect detectors could be used instead to implement the first rotary encoder 28.

Moreover, it will be apparent to those skilled in the art that it is not essential that the first rotary encoder be attached to an end of the spindle of the first motor 26. Indeed, with very minor modifications, the rotary encoder could be placed at any point of the drive train comprising the first motor 26, gearbox 30 and window mechanism 16.

The first gear wheel 34 is attached to the spindle of the second motor 32. The second gear wheel 36 is attached to the handwheel 14 and to a spindle on which the handwheel rotates. The second motor 32 and the spindle on which the handwheel rotates are so located that the first and second gear wheels engage with one another, such that when the handwheel is rotated, the second motor is driven. The second gear wheel has a diameter that is between three and four times the diameter of the first wheel. For each revolution of the handwheel, therefore, the first gear wheel makes between three and four rotations,>which increases the effective resolution of the second rotary encoder by between three and four times.

The handwheel 36 has a folding handle 38, which is shown in an extended position in FIG. 1. The handle can be moved into a folded position, and is engageable with a microswitch (not shown) in the folded position, which microswitch disconnects the second rotary encoder from the first control means.

The winder mechanism is formed with an outwardly projecting member 40, with piezoelectric crystals 42 and 44 located to each side of this member. Forces resulting from the weight of the window and the action of the mechanism are translated into torsional force acting through the member 40 onto one or other piezoelectric crystal.

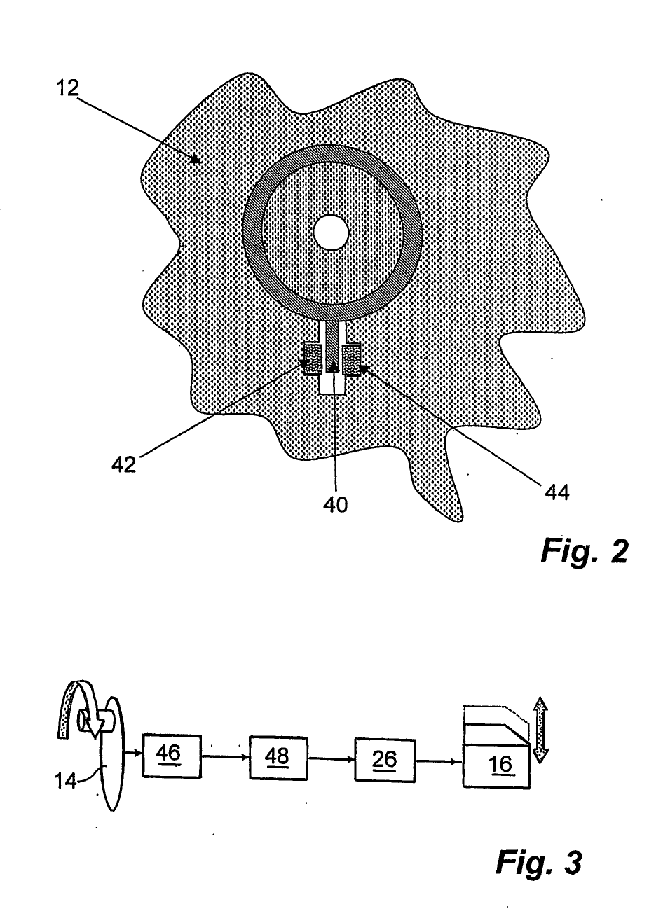

The arrangement of the member 40 and the piezoelectric crystals is shown more clearly in FIG. 2, in which the piezoelectric crystals are denoted by reference numerals 42 and 44.

FIG. 3 shows a first control scheme in which the speed of rotation of the handwheel is measured and a pulse width modulated (PWM) voltage of magnitude proportional to the speed of rotation of the handwheel is applied to the first motor. As the handwheel is rotated, pulses are generated by the second rotary encoder. A first clock 46 determines the frequency of the pulses and generates a signal representative of the speed of rotation of the handwheel. The signal representative of the speed of rotation of the handwheel is used to generate a PWM voltage which drives a first transistor h-bridge 48. The first motor 26 is connected across the first h-bridge 48.

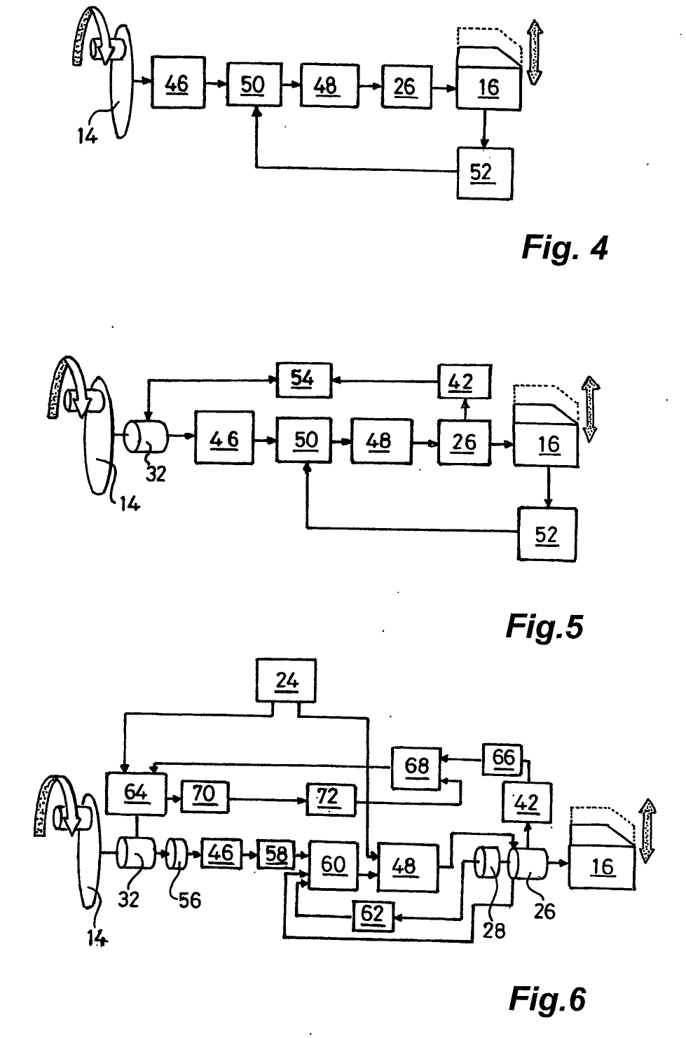

FIG. 4 shows a second control scheme in which the speed of rotation of the handwheel is measured and a feedback loop is used to ensure that the speed of rotation of the first motor is proportional to that of the handwheel. With only minor changes it would be possible instead to measure the angular displacement of the handwheel from a reference orientation and use the feedback loop to ensure that the angular displacement of the first motor from a reference orientation is proportional to that of the handwheel.

The first clock 46 determines the frequency of the pulses generated by the second rotary encoder to generate a signal representative of the speed of rotation of the handwheel. At the same time a second clock 52 determines the frequency of pulses generated by the first rotary encoder to generate a signal representative of the speed of rotation of the first motor. The signals representative of the speeds of rotation of the first motor and handwheel are compared by a microprocessor 50 to generate a speed error signal. The microprocessor generates a PWM voltage to drive the first h-bridge 48 and control the speed of rotation of the first motor so as to reduce the magnitude of the error signal.

FIG. 5 shows the control scheme of FIG. 4 modified by a further feedback loop, which enables a retarding force to be applied to the handwheel, which retarding force is approximately proportional to the torque developed by the first motor 26. The control scheme shown in FIG. 5 is as described in relation to FIG. 4. However, a voltage developed by the piezoelectric crystals 42 and 44, which is subjected to a compressive force due to the reaction torque on the motor, is applied to a microprocessor 54. The microprocessor 54 generates a PWM voltage to drive a second transistor h-bridge (not shown). The second motor 32 is connected across the second h-bridge and the PWM voltage generated by the microprocessor 54 causes the second motor to generate a torque which opposes the rotation of the handwheel.

Moreover, it will be apparent to those skilled in the art that the second motor 32 may be replaced by an electromagnetic clamp and controlled by the microprocessor 54 so that the braking force is a function of the torque developed by the first motor 26.

FIG. 6 shows a control scheme similar to that shown in FIG. 5, but with a further feedback loop to ensure that the torque generated by the second motor to oppose the rotation of the handwheel is proportional to the torque generated by the first motor.

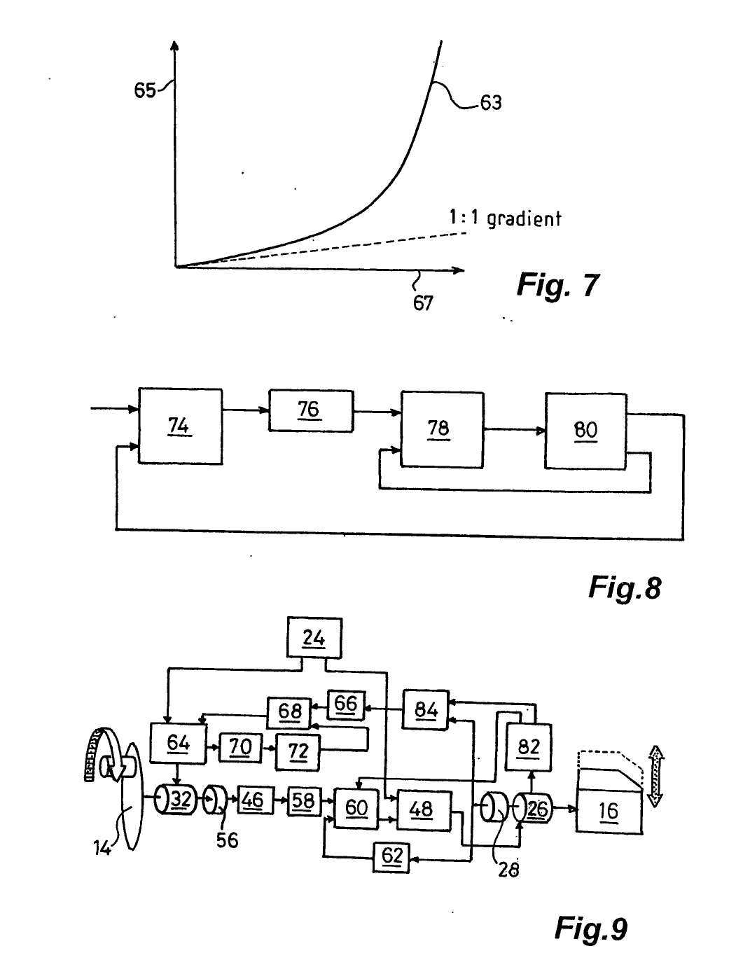

In the control scheme of FIG. 6 the handwheel 14 is rotated and causes the spindle of the second motor 32 to rotate and the second rotary encoder 56 to generate pulses. The first clock 46 measures the frequency of the pulses from the second rotary encoder and generates a signal representative of the speed of rotation of the handwheel. An amplifier 58 applies a gain to the signal representative of the speed of rotation of the handwheel to generate an amplified speed signal. The gain of the amplifier increases with the magnitude of signal representative of the speed of rotation of the handwheel. FIG. 7 shows the gain characteristic 63 of the amplifier 58 with gain plotted against magnitude of the signal representative of the speed of rotation of the handwheel. Gain is plotted on the y-axis 65 and magnitude of the handwheel speed signal on the x-axis 67. The gain of the amplifier therefore determines the ratio of the speeds of rotation of the first motor and the handwheel. The amplified speed signal is applied to a first proportional plus integral (PI) controller 60.

The spindle of the first motor 26 rotates and causes the first rotary encoder 28 to generate pulses. A third clock 62 measures the frequency of the pulses and generates a signal representative of the speed of rotation of the first motor. The signal representative of the speed of rotation of the first motor is applied to the PI controller 60. A current sensor (not shown) measures the current flowing through the first motor and generates a signal representative of the current flowing through the first motor. The current sensor transmits the signal to the first PI controller 60. The first PI controller 60 generates a PWM voltage to drive the first h-bridge 48 to cause the spindle of the first motor to rotate at the speed determined by the gain of the first amplifier 58, whilst ensuring that the current flowing through the motor remains below a safe limit. The current limiting operation of the first PI controller 60 is explained in more detail below in relation to FIG. 8. The battery 24, which was omitted from FIGS. 3 to 5 for the purpose of clarity, is shown in FIG. 6 connected to the first h-bridge 48 and the second h-bridge 64 across which the second motor 32 is connected.

The piezoelectric crystal 42 and 44 generates a voltage proportional to the torque developed by the first motor 26. An attenuator 66 attenuates the voltage generated by the crystal 42 to generate a signal representative of a fraction of the torque developed by the first motor 26. The attenuated torque signal is applied to a second PI controller. A current sensor 70 generates a signal representative of the current flowing through the second motor 32 from the second h-bridge 64. A second microprocessor 72 generates a signal representative of an estimated torque developed by the second motor 32 and applies this signal to a second PI controller 68. The second PI controller generates a PWM voltage to drive the second h-bridge 64 so as to cause the second motor 32 to generate a torque equal to the fraction of the torque generated by the first motor 26.

Turning to FIG. 8, the current limiting operation of the first PI controller 60 is shown. This can be used to project objects in the path of a closing window from damage, as well as detecting end-stops and preventing damage to the device. The PI controller 60 in fact comprises an outer, relatively slow PI controller 74, a current limiter 76 and an inner, relatively fast PI controller 78. In FIG. 8 the first h-bridge 48, first motor 26, first rotary encoder 28, second clock 62 and current sensor of FIG. 6 are represented by the functional block 80.

The outer PI controller 74 receives signals representative of a demanded motor speed from the amplifier 58 and signals representative of the actual motor speed from the first rotary encoder 28 and third clock 62 and generates a signal representative of a demanded current. The demanded current is that which will cause the actual motor speed to approach the demanded motor speed. The signal representative of the demanded current is transmitted to the current limiter 76, which either transmits the signal representative of the demanded current to the inner PI controller 78, or if the signal representative of the demanded current exceeds a threshold value, transmits a signal representative of a limited demanded current to the inner PI controller 78.

The inner PI controller receives the signal representative of the demanded current (whether or not limited) and a signal representative of the actual motor current from the current sensor. The inner PI controller generates a PWM voltage to drive the first h-bridge so as to cause the actual current flowing through the motor to approach the demanded current.

FIG. 9 shows a variation of the control scheme shown in FIG. 6, in which a torque developed by the first motor is calculated from parameters of the first motor related to torque, rather than measured directly. The operation of the first motor 26, first rotary encoder 28, second motor 32, second rotary encoder 56, first clock 46, amplifier 58, first PI controller 60, first h-bridge 48, attenuator 66, second PI controller 68, current sensor 70, microprocessor 72 and third clock 62 is as previously described in relation to FIG. 6. However, the first PI controller 60 receives the signals representative of the first motor current from voltage and current sensors 82 operable to generate signals representative of the voltage developed across, and current flowing in, the first motor 26.

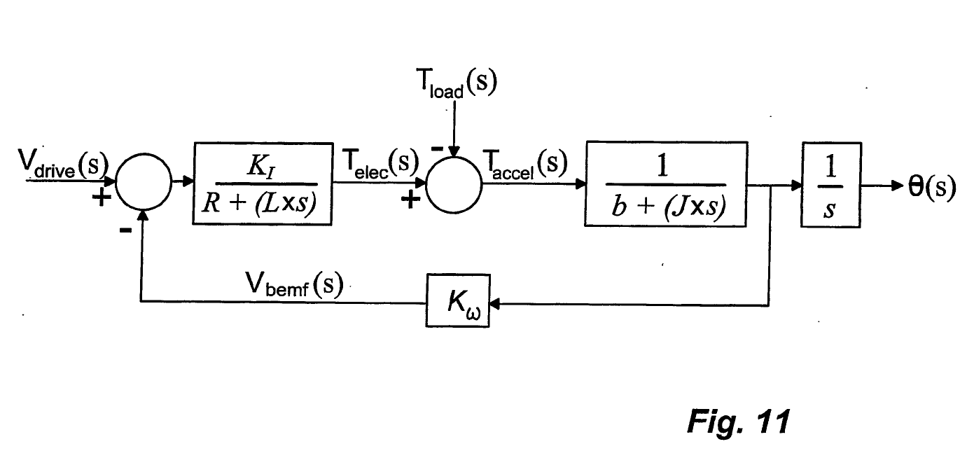

The voltage and current sensors 82 transmit signals representative of the voltage developed across, and current flowing in, the first motor 26 to a second microprocessor 84. The second microprocessor also receives pulses from the first rotary encoder 28 and generates a signal representative of the load torque developed by the first motor 26, which is transmitted to the attenuator 66. The second microprocessor 84 implements a model of the motor, which is explained in greater detail below with reference to FIG. 11. The attenuated torque signal is transmitted to the second PI controller 68 to cause the second motor 32 to generate a torque proportional to the load torque generated by the first motor, which torque opposes the rotation of the handwheel 14, as previously described.

Turning to FIG. 11, this shows the model implemented by the second microprocessor 84. In the following description it is to be assumed that signals representative of a particular variable are signals representative of the Laplace transform of that variable. The second microprocessor receives a signal representative of the voltage applied to the first motor 26, and the current through it and a signal representative of the angular displacement of the rotor of the first motor from a reference orientation. From previous angular displacement signals the second microprocessor determines the actual speed of rotation of the rotor of the first motor. Using the model an estimate of the motor current and speed may be made. The estimated speed generates a signal representative of the back emf generated by the first motor. The back emf signal is substracted from the motor voltage signal to generate a signal representative of the estimated voltage across the windings of the first motor. The second microprocessor uses the estimated windings voltage signal to generate a signal representative of the motor current and of the total electrical torque generated by the first motor 26. The second microprocessor also generates a signal representative of a predicted load torque generated by the first motor by comparing the actual current and speed against the estimates and subtracts the signal representative of the predicted load torque from the signal representative of the total electrical torque to generate a signal representative of the accelerating torque developed by the first motor. The second microprocessor generates a signal representative of the estimated speed of rotation of the rotor of the first motor from the accelerating torque signal, from which the back emf signal referred to earlier is generated.

The second microprocessor generates from the estimated rotor speed signal a signal representative of the estimated angular displacement of the rotor from the reference orientation and compares the estimated angular displacement signal with a signal representative of the actual angular displacement of the rotor generated by the first rotary encoder 28. The second microprocessor adjusts the predicted load torque signal to reduce the difference between the actual and estimated angular displacement signals and the difference between the actual and estimated motor current.

The variables shown in the model of FIG. 11 are as follows:

| | |
|---|---|
| V_{drive}(s)˜ | Laplace transform of the voltage applied to the first motor |
| | 26; |
| K_{I}˜ | torque constant of the first motor; |
| R˜ | armature resistance of the first motor; |
| L˜ | armature inductance of the first motor; |
| s˜ | the Laplace variable; |
| T_{elec}(s)˜ | Laplace transform of the total electrical torque of the first |
| | motor; |
| T_{load}(s)˜ | Laplace transform of the load torque of the first motor; |
| T_{accel}(s)˜ | Laplace transform of the accelerating torque of the first |
| | motor; |
| b˜ | friction coefficient of the first motor and gearbox; |
| J˜ | inertia of the rotor of the first motor and gearbox; |
| θ(s)˜ | Laplace transform of the estimated angular displacement of |
| | the rotor of the first motor; |
| K_{∞}˜ | electric constant of the first motor; and |
| V_{bemf}˜ | Laplace transform of the estimated back emf of the first |
| | motor. |

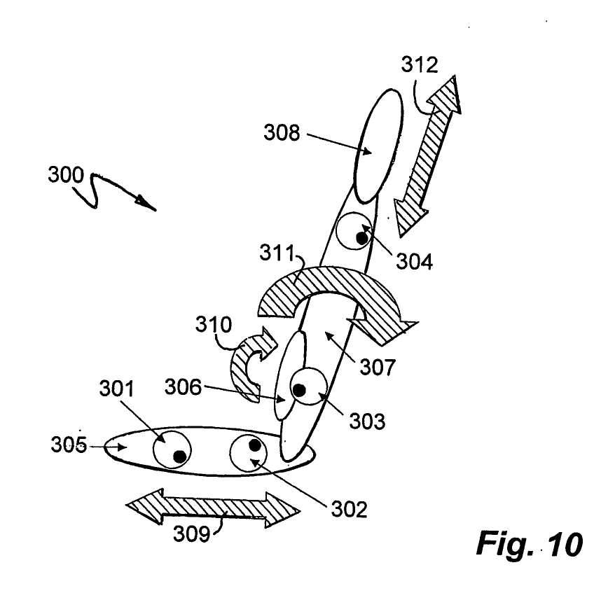

FIG. 10 shows an automotive seat where a handwheel can be used to adjust the position sections of the seat. The seat 300 is formed from a number of sections. The base 305 can be moved relative to the vehicle using handwheel 301 in the direction shown by arrow 309. The lumbar support 306 can be moved relative to the seat back 307 using handwheel 303 in the direction shown by arrow 310. The seat back 307 may be moved relative to the base 305 using handwheel 302 in the direction shown by arrow 311. The headrest 308 may be moved relative to the seat back 307 using handwheel 304 in the direction shown by arrow 312.

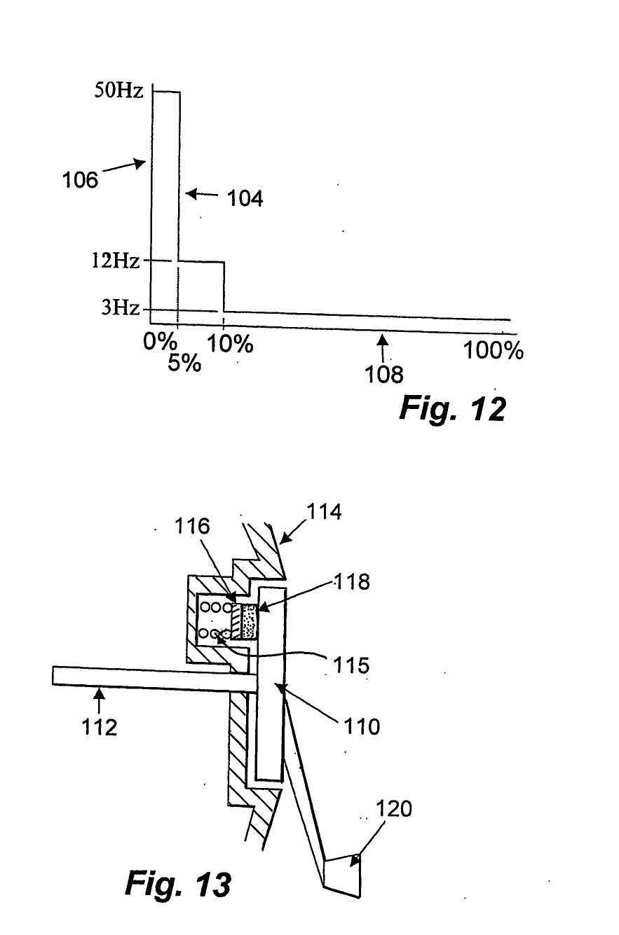

FIG. 12 shows the frequency response of a variable frequency digital low-pass filter with cut-off frequency plotted against magnitude of a signal representative of the speed of rotation of the handwheel. Cut-off frequency is plotted on the y-axis 106 and magnitude of the handwheel speed signal on the x-axis 108. The variable frequency digital low-pass filter could be used in any of the control schemes described above. In the control scheme shown in FIG. 3, for example, the variable frequency low-pass filter would be interposed between the clock 46 and the h-bridge 48.

The filter, the frequency response of which is shown in FIG. 12, is designed to be used in a control scheme that defines a maximum speed of rotation of the handwheel, such that increases of speed of rotation of the handwheel above the maximum speed do not cause a corresponding increase in speed of movement of the moveable body. This is not an essential feature of the filter, however.

As can be seen from FIG. 12, the filter passes all signals with frequencies below 50 Hz for speeds of rotation of the handwheel up to five percent of the maximum speed. For speeds of rotation of the handwheel between five and ten percent of the maximum speed the filter passes all signals with frequencies below 12 Hz. For speeds of rotation of the handwheel between ten and one hundred percent of the maximum speed the filter passes all signals with frequencies below 3 Hz.

The effect of this is to slow the speed of response of the first motor controller with increasing speed of the handwheel. This arrangement has been found to give very sensitive control of the speed of the moveable body at low speeds of rotation of the handwheel, for which a high speed of response of the first motor controller is required, and relatively insensitive control of the speed of the moveable body at high speeds of rotation of the handwheel. It is important that the control of the speed of the moveable body at high speeds of rotation of the handwheel be relatively insensitive, since it is difficult for a user to maintain a constant, high speed of rotation of the handwheel, and the speed of the moveable body would otherwise be variable to a degree that would irritate the user. This is because the user would be used to conventional mechanical actuation, in which the inertia of the handwheel, gear train and moveable body tend to prevent or reduce sudden variations in the user's speed of rotation of the handwheel.

FIG. 13 shows an improved arrangement of a handwheel that forms part of a window opening mechanism. The handwheel 110 is mounted on a shaft that is attached to the body of an automotive door. A portion of the body is shown in FIG. 13, denoted by reference numeral 114. A compression spring 115 is accommodated in a recess in the body and acts on a brake block 116. The brake block is covered by a felt pad 118 and arranged such that the action of the spring urges the felt pad 118 into engagement with a rear face of the handwheel 110.

In addition to preventing movement of the handwheel 110 due to the weight of a handle 120 attached to the handwheel, the brake block assists the smooth operation of the window by the user, since the brake block resists abrupt-changes of the speed of rotation of the handwheel by the user.

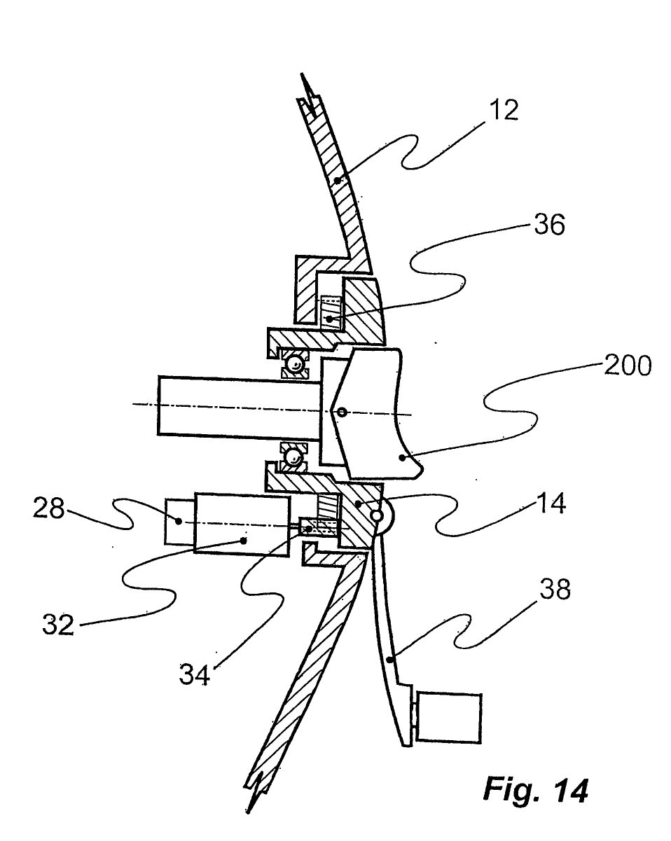

FIG. 14 shows the addition of a rocker switch 200 in the center of the handle 14. The switch is mounted in such a way that it is stationary whilst the handle 14 can be rotated around the switch 14. The rocker switch 14 is used as a further manual control that can be used to raise/lower one or several of the vehicle's windows.

It will be apparent that although the foregoing description relates to several embodiments of the invention, the invention encompasses other embodiments as defined by the foregoing statements of the invention.

1-42. (canceled)

43. A handwheel-operated device comprising a fixed body, a handwheel and a moveable body, the handwheel being rotatable relative to the fixed body and the moveable body moveable relative to the fixed body, and the device further comprising a first motor operable to actuate the moveable body, first sensor means responsive to the rotation of the handwheel and first control means operable in conjunction with the first sensor means to cause the first motor to rotate upon an angular displacement and/or angular velocity of the handwheel.

44. A device according to claim 43, wherein the first control means is operable to modulate a voltage applied to the first motor.

45. A device according to claim 44, wherein the first control means is operable to modulate the voltage applied to the first motor such that the magnitude of the voltage is substantially proportional to the angular velocity of the handwheel.

46. A device according to claim 44, wherein the first control means is operable to modulate the voltage applied to the first motor such that an angular displacement and/or angular velocity of the handwheel results in a corresponding displacement and/or velocity of the moveable body.

47. A device according to claim 44, wherein the first control means is operable to modulate the voltage applied to the first motor in dependence on the angular velocity of the handwheel such that the velocity of the moveable body is non-linearly related to the angular velocity of the handwheel, the ratio of handwheel speed to moveable body speed decreasing with increasing handwheel speed.

48. A device according to claim 43, further comprising a variable low-pass signal filter operable to receive signals representative of the angular displacement and/or angular velocity of the handwheel from the first sensor means and to transmit signals below a cut-off frequency to the first control means and to attenuate signals above the cut-off frequency so as to prevent them from reaching the first control means, the cut-off frequency being determined by the angular velocity of the handwheel.

49. A device according to claim 43, wherein the first sensor means comprises an angular displacement sensor.

50. A device according to claim 49, wherein a first gear wheel is attached to the shaft of the angular displacement sensor, a second gear wheel is attached to the handwheel, and the first and second gear wheels are engageable with one another either directly or via one or more intermediate gears, so that each revolution of the second gear wheel causes the first gear wheel to rotate through more than 360°.

51. A device according to claim 43, wherein the first sensor means comprises a second motor, a shaft of which is coupled for rotation to the handwheel, and measurement means for measuring one or more parameters related to a speed and direction of rotation of the shaft of the second motor, and computation means operable to derive a speed and direction of rotation of the shaft of the second motor, and hence a speed and direction of rotation of the handwheel, from the one or more measured parameters.

52. A device according to claim 51, further comprising second sensor means operable to determine a torque developed by the first motor, torque feedback means coupled to the handwheel and second control means operable in conjunction with the second sensor means to cause the torque feedback means to oppose the rotation of the handwheel.

53. A device according to claim 52, wherein the second sensor means comprises measurement means for measuring one or more parameters related to the torque of the first motor, and computation means operable to derive a torque of the first motor from the one or more measured parameters.

54. A device according to claim 52, wherein the torque feedback means comprises a variable brake engageable with the handwheel under the control of the second control means.

55. A device according to claim 52, wherein the torque feedback means comprises a second control means that is operable to supply current to the second motor so as to oppose the rotation of the handwheel.

56. A device according to claim 43, further comprising third sensor means operable to determine an electromotive force (emf) developed by a supply voltage, the first control means being operable in conjunction with the third sensor means to modulate the voltage applied to the first motor so that decreases in the emf do not cause decreases of the speed of the moveable body.

57. A device according to claim 43, further comprising biasing means and mechanical braking means, the biasing means being operable to urge the mechanical braking means into engagement with the handwheel so as to oppose the rotation of the handwheel.

58. A device according to claim 43, wherein the handwheel is provided with a handle movable between a folded position and an extended position.

59. A device according to claim 58, wherein the body of the device and the handle of the handwheel are formed such that in the folded position the handle engages with the body so as to prevent rotation of the handle relative to the body.

60. A device according to claim 58, further comprising first switch means engageable with the handle, such that the first control means is operable to cause the first motor to move the moveable body only when the handle is in the extended position.

61. A device according to claim 43, wherein the device is to control the level to which a window is open.

62. A method of controlling a motor of a handwheel-operated device, the device having a fixed body, a handwheel, a moveable body, gearing and a motor, the handwheel being rotatable relative to the fixed body and the motor being operable to move the moveable body relative to the fixed body, the method comprising sensing rotation of the handwheel and causing the motor to move the moveable body in dependence upon the angular displacement or angular velocity of the handwheel.
